(19) United States
(12) Patent Application Publication
(10) Pub. No.: US 2020/0396199 A1
(43) Pub. Date: Dec. 17, 2020

(54) COMMUNICATION EVALUATION AND MANAGEMENT

(71) Applicant: International Business Machines Corporation, Armonk, NY (US)

(72) Inventors: Paul R. Bastide, Ashland, MA (US); Robert E. Loredo, North Miami Beach, FL (US); Matthew E. Broomhall, Goffstown, NH (US)

(21) Appl. No.: 16/440,346

(22) Filed: Jun. 13, 2019

(51) Int. Cl. H04L 12/58; H04L 12/26

(52) U.S. Cl. CPC H04L 51/34; G06F 17/2705; H04L 43/045; H04L 51/16

(57) ABSTRACT

Aspects of this disclosure relate to evaluating and managing communication within an organization. A message is detected that includes at least one element from an initiating user. Communication relating to the message is tracked as the message is disseminated across a plurality of users. One or more miscommunicated elements of the at least one element are identified by evaluating the communication. One or more miscommunications of the message between one or more users of the plurality of users that caused the miscommunicated element(s) is determined by evaluating how the message was disseminated across the plurality of users.

### BACKGROUND

A user may use a plurality of media platforms to transmit messages through an organization. For example, a user may post a single message on an online forum on the Internet or on an intranet of the organization. Alternatively, the user may send multiple messages through email or using chat applications or the like. Subsequent users may themselves further send the message to other users or otherwise communicate or implement the message.

### SUMMARY

Aspects of the present disclosure relate to a method, system, and computer program product relating to evaluating and managing communication within an organization. For example, the method may include detecting a message that includes at least one element from an initiating user. The method may further include tracking communication relating to the message as the message is disseminated across a plurality of users. The method may further include determining, by evaluating the communication, one or more miscommunicated elements of the at least one element. The method may further include determining, by evaluating how the message was disseminated across the plurality of users, one or more miscommunications of the message between one or more users of the plurality of users.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which a controller evaluates and manages communication between a plurality of user devices.

FIG. 2 depicts a conceptual flowchart of communication between a plurality of users.

FIG. 3 depicts a conceptual box diagram of a computing system that may be configured to evaluate and manage communication within an organization.

FIG. 4 depicts an example flowchart of evaluating and managing communication within an organization.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to evaluating and managing communication between users, and more particular aspects relate to evaluating fidelity of dissemination and implementation of elements of a message across users of an organization. While the present disclosure is not necessarily limited to such applications, various aspects of the disclosure may be appreciated through a discussion of various examples using this context.

A leader within an organization may send a message that includes a few points or elements to a few subordinates, who may themselves communicate that message and the contained elements to their own subordinates. As the message is disseminated through the organization, some users may incorrectly communicate the message, such as by forgetting an element or modifying an element or the like. Over a period of time the message may be implemented by end-line users in its various forms, which may result in confusion, frustration, and/or a general lack of efficiency as alternate versions of this message are discovered by the end-line users. In some examples, end-line users may find it difficult or impossible to identify which version is the intended version and/or which are the intended elements. Further, it may be difficult or impossible for the leader to identify where the communication went awry after the fact, and/or to detect the miscommunication as it is occurring.

Aspects of this disclosure are intended to improve or solve these problems. For example, a controller within a computing system may be configured to track the dissemination of messages within an organization and identify any lack of fidelity of elements of those messages. The controller may track messages across a plurality of media platforms. In some examples, the controller may further identify a general trend of users over time, identifying users that are relatively better or worse at communicating various types of messages. For example, some users may be better at maintaining element fidelity while communicating messages meant to inspire, while other users may be better at maintaining element fidelity while communicating messages meant to direct, while other users may be relatively better at maintaining element fidelity while communicating messages meant to educate.

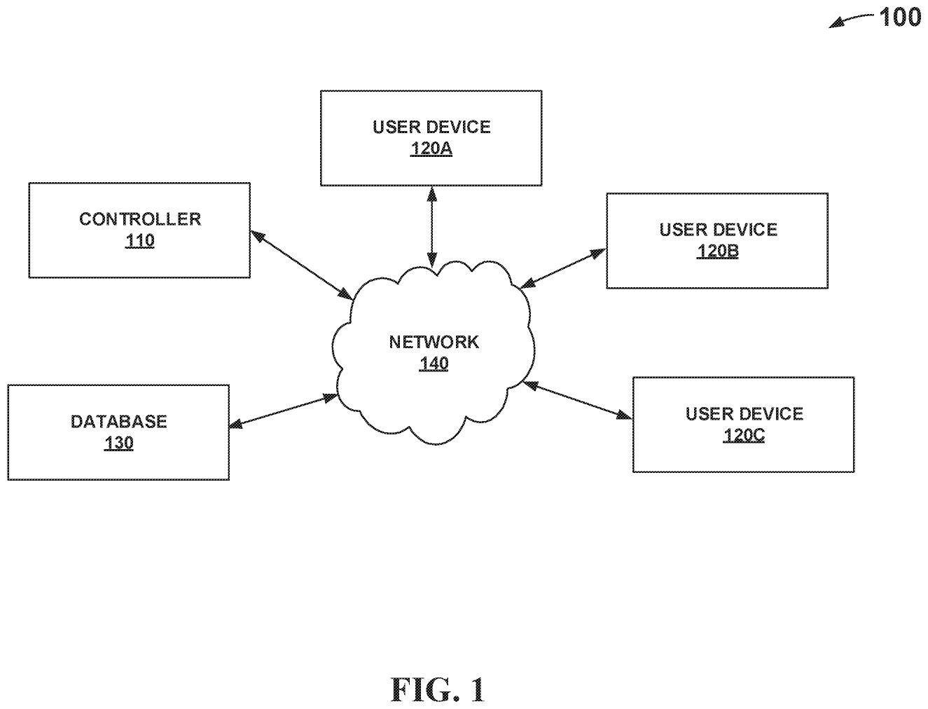

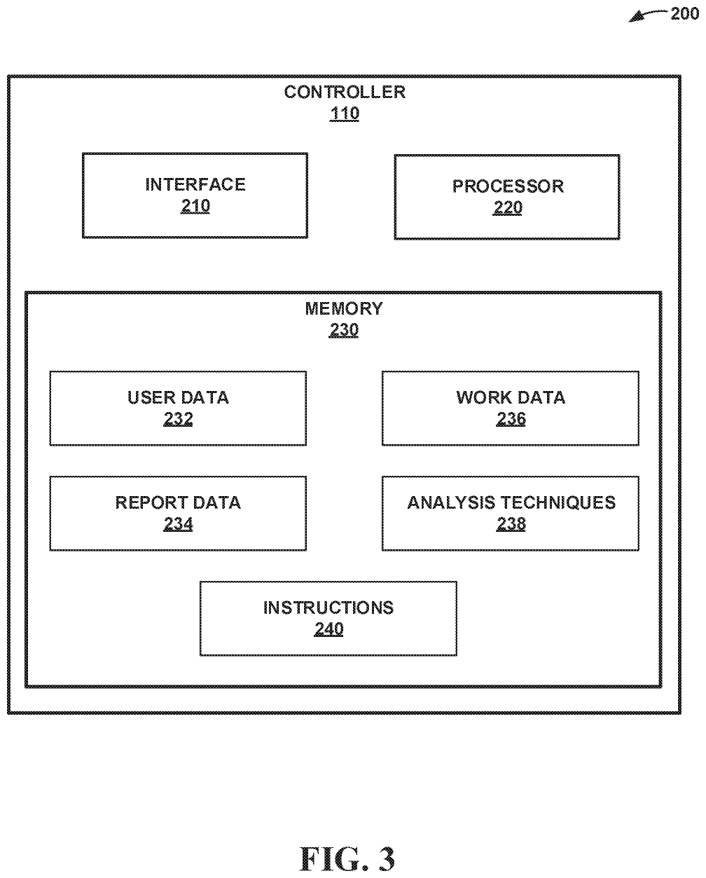

For example, FIG. 1 depicts system 100 that includes controller 110 that is configured to evaluate and manage communication between users. Controller 110 may include a computing device, such as computing device 200 of FIG. 3 that includes a processor communicatively coupled to a memory that includes instructions that, when executed by the processor, cause controller 110 to execute the operations described below. Controller 110 may monitor communication as sent between one or more user devices 120A, 120B, 120C (collectively referred to as “user devices 120”). User devices 120 may include computing devices (similar to computing device 200 of FIG. 3 as described below) such as laptops, desktop computers, mobile phones, or the like. Controller 110 may store and/or access communication data between user devices 120 in database 130, which may be a computing device as described herein. For example, database 130 may include a server or a rack of servers or a laptop or a desktop or the like. Though only three user devices 120 and one database 130 are depicted for the sake of illustration, it is to be understood that controller 110 may evaluate and manage communication between users for systems that include far more user devices 120 and/or more databases 130 or no database 130 or the like.

Controller 110 may gather communication data between user devices 120 over network 140. Network 140 may include a computing network over which computing messages may be sent and/or received. For example, network 140 may include the Internet, a local area network (LAN), a wide area network (WAN), a wireless network, or the like. Network 140 may comprise copper transmission cables, optical transmission fibers, wireless transmission, routers, firewalls, switches, gateway computers and/or edge servers. A network adapter card or network interface in each computing/processing device (e.g., controller 110, user devices 120, and/or database 130) may receive messages and/or instructions from and/or through network 140 and forward the messages and/or instructions for storage or execution or the like to a respective memory or processor of the respective computing/processing device.

Though network 140 is depicted as a single entity in FIG. 1 for purposes of illustration, in other examples network 140 may include a plurality of private or public networks. For example, user devices 120 may communicate together over a private WLAN of network 140, such as a work WLAN network. Further, controller 110 may communicate with database 130 over a private LAN of network 140. Additionally, controller 110 may communicate with user devices 120 over a public portion of network 140 using the Internet.

Controller 110 may gather and/or receive a plurality of communication data. In some examples, controller 110 may receive an opt-in from one or all of user devices 120 prior to gathering and/or receiving this data. For example, one or many or each of user devices 120 may affirmatively go to a software application associated with controller 110 in order to authorize controller 110 to gather and/or receive data described herein. In some examples, a single user device 120A that has administrative privileges over many or substantially all user devices 120 may authorize controller 110 to gather and/or receive data from many or all user devices 120.

In some examples, controller 110 may provide computing agents that are housed on user devices 120 to forward messages or ongoing project work or the like to controller 110. These computing agents may only forward along messages and/or work product that meet the criteria of data in database 130, which is to say data that relates to a message being communicated across an organization. Alternatively, or additionally, controller 110 may itself gather or collect data that is sent between user devices 120 as this data is transmitted over network 140 (e.g., by evaluating messages that traverse a firewall of network 140).

Controller 110 may gather communication data across a plurality of media platforms. For example, controller 110 may gather emails, chatting application messages, public online notices (e.g., messages put on web boards that are available to all or many people of an organization), or the like. Further, controller 110 may gather verbal communication data. For example, controller 110 may gather data spoken over web conferences or phone calls or the like. Controller 110 may utilize speech-to-text techniques or the like to identify words that are verbally spoken between users.

Controller 110 may use natural language processing (NLP) techniques to determine elements of a message and track a message. For example, controller 110 may use NLP techniques to identify a general meaning of a message, identify who the message is intended for, identify a time frame of the message, or the like. Controller 110 may use NLP techniques to identify that a first message sent between user device 120A and user devices 120B relates to a second message between user device 120B and user device 120C.

In some examples, controller 110 may identify portions of work product as being related to communication. For example, controller 110 may use NLP techniques to detect that an email message from user device 120A as sent to user device 120B relates to using a first technique rather than a second technique. Further, controller 110 may detect user device 120C using the second technique. Controller 110 may then detect a web conference between user device 120B and 120C relating to using the first technique. Subsequently, controller 110 may detect user device 120C using the first technique.

Controller 110 may determine a fidelity of elements of a message as the message is communicated and/or implemented across user devices 120. For example, controller 110 may track if all elements are communicated between user devices 120. Further, controller 110 may track if elements are communicated accurately, and/or if a meaning or a nuance or an emphasis of elements changes as the elements are communicated. For example, controller 110 may detect a message, “Please make sure that all projects are created with a deadline at least a month before each quarter so we have a buffer” between user device 120A and user device 120B, and therein detect a second message, “All projects are to have deadlines at least four weeks before each quarter” between user devices 120B and 120C. Controller 110 may detect that the message has changed from relating to a month to relating to four weeks, and further that the message has further changed from relating to all projects that are created to simply all projects. Controller 110 may detect both of these as miscommunications. As used herein, a miscommunication may include an instance where one or more elements or an overall tone of a message are altered or eliminated between an initial message and a subsequent message that relates to substantially the same thing.

Controller 110 may be configured to generate an alert for one or more users. Controller 110 may generate this alert in response to detecting this miscommunication. For example, using the project deadline example above, the alert may describe one or both detected miscommunications. Controller 110 may provide this alert to the users via a message sent over network 140 to user devices 120. For example, controller 110 may send an email or the like with details of the miscommunication.

Controller 110 may send this alert to all users associated with a miscommunication or to only some users of the miscommunication. For example, controller 110 may have access to an organization chart (hereinafter referred to as an “org chart”) that indicates relative hierarchical levels of one or more users within an organization, and may therein send the alert to a user on a relatively “higher” level. Sending the alert to a higher level may improve an ability of users using the system to respond in a manner desired by the org chart, where information and updates and directives generally are sent “down” the org chart. Alternatively, controller 110 may send the alert to whichever user sent the message that included the miscommunication. Sending the alert to the user that sent the miscommunication message may enable this user to verify that a mistake was made and/or correct their mistake with minimal stress or embarrassment or the like.

Controller 110 may gather this communication data over an extended period of time. After an extended communication gathering period, controller 110 may evaluate which users are relatively better or worse at communicating elements accurately. In some examples, controller 110 may determine various elements that users may communicate better or worse. For example, controller 110 may determine that messages that originate from user device 120B incorrectly communicate time elements at a relatively high rate, while messages that originate from user device 120C incorrectly communicate project details at a relatively high rate. Alternatively, or additionally, controller 110 may determine various types of messages that users may communicate relatively better or worse. For example, controller 110 may determine that user device 120B has a relatively high rate of miscommunicating elements of inspirational messages, while controller 110 determines that user device 120C has a relatively high rate of miscommunicating elements of directive messages.

Controller 110 may generate reports on such compiled miscommunication data. For example, controller 110 may generate a graphical report that details where and how miscommunications are detected on various types of elements and/or with various types of messages (e.g., inspirational messages, directive messages, education messages, or the like). In some examples, reports as generated by controller 110 may further indicate media platforms that have a relatively better or worse success rate. For example, controller 110 may determine that emails tend to have a relatively better success rate at communicating all elements, while verbal conversations tend to have a relatively worse success rate.

In some examples, controller 110 may further determine that some media platforms may have an improved performance for the receiving users. For example, controller 110 may determine that messages sent over email have a higher rate of success at relaying all elements accurately but also have a relatively lower rate of success at getting the recipient to implement elements of the message correctly. Controller 110 may identify that such a rate of implementation specifically drops when a number of elements within the email increases. Conversely, controller 110 may identify that web conferences have a relatively higher rate of end-user implementation, even if web conferences also have a relatively lower rate of accurate discussion of each element. Controller 110 may include such determinations, including visual depictions (e.g., showing different types of messages in different visual ways), in generated reports.

Controller 110 may provide these reports to one or more users. For example, controller 110 may generate a monthly report on this miscommunication data for a leader or head of an organization (e.g., such as a chief executive officer or a relevant vice president or the like). Further, controller 110 may generate a graphical representation of communication across an organization that may depict accurate communication and/or relatively inaccurate communication as the communication flows through users of an organization.

In some examples, controller 110 may communication data to suggestion realignment of an org chart for communication purposes, and/or a rerouted communication path. For example, controller 110 may determine that a miscommunication by a user of user device 120B is a fifth miscommunication when added to database 130 of communication, where four miscommunications is a threshold, such that some communication may be better routed around or through or away from the user of user device 120B. Controller 110 may identify that the user of user device 120B miscommunicates certain varieties of elements (e.g., dates, or costs, or the like), and/or certain types of messages (e.g., inspirational, or educational, or directive, or the like). As such, controller 110 may suggest rerouting communication that relates to these troublesome elements and/or topics away from the user. In some examples, controller 110 may further suggest an alternate user and/or path, such as another user on the same level of an org chart as the miscommunicating user.

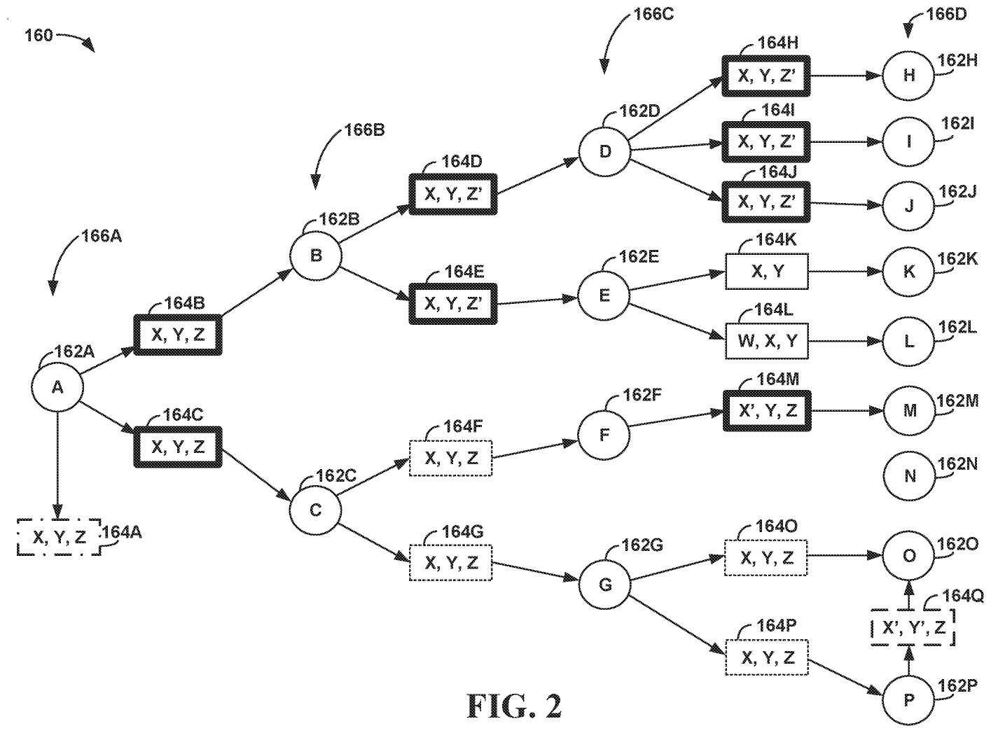

For example, FIG. 2 depicts a conceptual flowchart 160 of a plurality of users 162A-162P (collectively referred to as “users 162”) communicating a plurality of messages 164A-164Q (collectively referred to as “messages 164”). Controller 110 may generate flowchart 160 as a report for a leader. As discussed herein, controller 110 may monitor these messages 164 as they are spread over time. Controller 110 may detect these messages 164 over a plurality of media platforms.

For example, controller 110 may detect message 164A in which user 162A communicated elements X, Y, Z to a public forum available to all users 162. Further, controller 110 may detect messages 164B, 164C sent by user 162A to users 162B, 162C over email. Subsequent messages 162 may be detected by controller 110 as sent over short message service (SMS) text (e.g., using mobile phone), web conferences, phone calls, or the like. Further, controller 110 may generate flowchart 160 such that messages 164 are depicted with different borders to depict these different platforms on which the message was identified. For example, as depicted in FIG. 2, thick unbroken borders may indicate emails, while thin unbroken borders may indicate texts, while dotted borders may indicate web conferences, while dashed borders indicate web chats, while dotted and dashed indicate online postings. Other types of messages across other platforms are also possible.

Controller 110 may detect one or more miscommunications. For example, controller 110 may detect that message 164H as sent from user 162D to user 162H includes elements X, Y, Z′ rather than X, Y, Z. Controller 110 may detect using the techniques described herein that element Z′ is different than element Z. Controller 110 may detect that this miscommunication did not originate with user 162D, but instead that the miscommunication is traced back to user 162B. In some examples, in response to detecting this, controller 110 may send an alert and/or correction to each user that was involved with this miscommunication (e.g., user 162B, 162D, 162E, 162H, 162I, and 162J). In other examples, controller 110 may detect organizational levels 166A-166D (collectively, “organizational levels 166”) of users 162, and only send alerts to users 162 that are on relatively higher organization levels 166. For example, controller 110 may send an alert to user 162B, enabling user 162B to send a correction to all users.

Controller 110 may determine whether to send an alert to all users 162 or users 162 on high organization levels 166 based on a severity of the mistake. For example, if mistake relates to an intended font to use in documents, controller 110 may determine that this is a low severity correction. In response to determining that this is a low severity issue, controller 110 may generate this alert to only the user 162 on the relative highest organizational level 166. Conversely, if controller 110 determines that a mistake relates to how a bill a customer, controller 110 may identify this as a high severity correction (e.g., such that the mistake deals with a relatively high-stakes issue), and therein autonomously and immediately send a correction to all associated users 162.

In some examples, controller 110 may further send an alert to users 162 that were not involved in the miscommunication. For example, controller 110 may send the alert to a respective user 162A that is on a higher organization level 166A than user 162B that miscommunicated the initial message 164B, such that user 162A on a higher organization level 166A may help coach the miscommunicating user 162B. For another example, controller 110 may send the alert to initiating user 162A that sent the initial messages 164A-164C to inform initiating user 162A that their messages 164A-164C are being miscommunicated and/or misinterpreted down the line. Informing an initiating user 162A that their messages 164A-164C are being miscommunicated and/or misinterpreted may help this user 162A clarify their messages 164A-164C over time to reduce or eliminate future miscommunications.

In some examples, controller 110 may detect a miscommunication as message 164K that includes less elements (X, Y rather than X, Y, Z′) than was sent by user 162E to user 162K. Additionally, or alternatively, controller 110 may be configured to detect a miscommunication as message 164L that contains alternate elements (W, X, Y, rather than X, Y, Z′) than message 164E that was sent to user 162E.

Further, controller 110 may detect that some media platforms may relate to more or worse miscommunications. For example, controller 110 may detect that text messages 164K, 164L may have relatively more severe miscommunications, while web conference messages 164F, 164G, 1640O 164P are relatively less likely to have mistakes. In some examples, controller 110 may compile a list of all miscommunication and link factors across these miscommunications, such as a topic, a list of elements, media platforms, or the like.

In some examples, controller 110 may further analyze whether or not messages 164 reached all users 162. For example, controller 110 may recognize that user 162N never received any of messages 164. In some examples such as this, controller 110 may remind a user (e.g., user 162F) to generate a message for user 162N. Alternatively, controller 110 may identify another user 162G that has been relatively reliable in disseminating messages 164, therein recommending (e.g., recommending to user 162C) that user 162G be responsible for some or all communication (e.g., communication with user 162N, and/or communication that relates to the subject of messages 164, or the like).

As described above, controller 110 may include computing device 200 with a processor configured to execute instructions stored on a memory to execute the techniques described herein. For example, FIG. 3 is a conceptual box diagram of such computing device 200 of controller 110. While controller 110 is depicted as a single entity (e.g., within a single housing) for the purposes of illustration, in other examples controller 110 may include two or more discrete physical systems (e.g., within two or more discrete housings). Controller 110 may include interfaces 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with user devices 120, database 130, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to evaluate and manage communication between users of an organization. Controller 110 may utilize processor 220 to evaluate and manage communication. Processor 220 may include, for example, microprocessors, digital signal processors (DSPs), application specific integrated circuits (ASICs), field-programmable gate arrays (FPGAs), and/or equivalent discrete or integrated logic circuit. Two or more of processor 220 may be configured to work together to evaluate and manage communication.

Processor 220 may evaluate and manage communication of an organization according to instructions 240 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may evaluate and manage communication according to instructions 240 of one or more applications (e.g., software applications) stored in memory 230 of controller 110.

In addition to instructions 240, in some examples gathered or predetermined data or techniques or the like as used by processor 220 to evaluate and manage communication may be stored within memory 230. For example, memory 230 may include information described above that may be stored in database 130, and/or may include substantially all of database 130. For example, memory 230 can include user data 232, which may include a list of many or all uses of an organization for which controller 110 may evaluate and manage communication.

User data 232 may include a general profile of each user, such as profiles that provide sufficient information to identify each user through data gathered over network 140. For example, user data 232 may include a voice profile and facial recognition pattern and the like for one or more users, such that controller 110 may use user data 232 to identify these users when they communicate over network 140 (e.g., using a web conference). User data 232 may also include a set of user devices 120 that are associated with each user (e.g., such as a laptop and a cell phone of the user) and/or a set of usernames or online identifiers for each user (e.g., including an email address or social media profile or the like) to use to link messages to a user. User data 232 may further include a set of preferences for each user, such as whether the users want controller 110 to send corrections to other users when a user says something incorrectly, or whether a user wants controller 110 to send a correction only to the miscommunicating user, or the like. In some examples, user data 232 may include a user placement on an org chart or the like.

In certain cases, user data 232 may include a general reliability score of the users. For example, some users may be relatively more reliable at communicating messages. In some examples, user data 232 may include a plurality of reliability scores for different types of elements and/or different types of messages.

Memory 230 may also include report data 234. Report data 234 may include data on such things as the reliability of a plurality of users across a plurality of elements for a plurality of topics. In some examples, report data 234 may include graphical data such as flowchart 160 of FIG. 2. Report data 234 may be updated with real-time messages and work product as detected by controller 110 over network 140.

As depicted in FIG. 3, memory 230 includes work data 236. Work data 236 may include work that has been done and/or is projected to be done by the organization. In some examples, controller 110 may detect changes in work data 236 as a result of communication. For example, if project data include documentation in a first font, and there is a message that is sent about preferring a second font over the first font, after which documentation within work data 236 is detected as changing to the second font, controller 110 may determine this as an example of successful communication. Similarly, if controller 110 detects the documentation within work data 236 as staying in the first font, or changing to a third font (rather than the second font), controller 110 may determine this as an example of miscommunication and/or as a result of a previous miscommunication.

Memory 230 may also include analysis techniques 238 that controller 110 may use to recognize and analyze communication elements and topics in data as gathered from user devices 120 over network 140. For example, analysis techniques 238 may include such data analyzing techniques as NLP techniques, image recognition techniques, speech-to-text techniques, or the like. NLP techniques can include, but are not limited to, semantic similarity, syntactic analysis, and ontological matching. For example, in some embodiments, processor 220 may be configured to parse messages from user devices 120 and/or directed to user devices 120 to determine semantic features (e.g., word meanings, repeated words, keywords, etc.) and/or syntactic features (e.g., word structure, location of semantic features in headings, title, etc.). Ontological matching could be used to map semantic and/or syntactic features to a particular concept. The concept can then be used to determine the subject matter. In this way, using NLP techniques, controller 110 may, e.g., identify an email received by one or more user devices 120 as including a first message with a first element, and/or identify text messages sent between user devices 120 as relating to that first message and including (or not) that first element, or the like.

Similarly, analysis techniques 238 may include image recognition techniques such as optical character recognition (OCR) for identifying text within received images, or general shape identification and/or recognition techniques, or object tracking techniques where images are received as a stream of images (e.g., as part of a video feed). Controller 110 may use these analysis techniques 238 to analyze image data sent between user devices 120 or generated by user devices 120 or the like. For example, controller 110 may identify words being written on a white board during a web conference using OCR. Further, analysis techniques 238 may include speech-to-text techniques that may be used by controller 110 to identify the text of speech said by users to track messages as they are communicated across network 140.

With this computing device 200, controller 110 may evaluate some or all communication of an organization to identify and generate reports on miscommunication. For example, as discussed herein, controller 110 may gather or otherwise receive data from instant chatting applications, group chatting applications, social media platforms, email platforms, or the like. Controller 110 may generate or otherwise use a pipeline to gather or receive this communication data, and/or use an interceptor to gather this communication data. Once received, all communication data may be stamped with a time and date (e.g., as kept in coordinated universal time or UTC), to better store and reference later.

Controller 110 may identify or gather the org chart (e.g., from an enterprise directory with employee-manager relationships or the like. In some examples, controller 110 may create and/or references users as a comma separated value (CSV) file. For example, controller 110 may be authorized by a leader of an organization (e.g., user A), after which controller 110 generates a tree data structure of the below org chart from an intranet of the organization:

### USER A>USER B, USER A>USER C, USER A>USER D

### USER C>USER D, USER C>USER F

### USER E>DELEGATE[USER F]

In this example, each user may be identified as a node, where nodes that are not identified as leaders (e.g., managers) are leaf nodes. Controller 110 may further identify relationships with a leaf node as unidirectional (e.g., indicating that the leaf node is lead by the “higher” node as per the org chart). This file may then be ready for processing for data according to the techniques described herein (e.g., which may include loading the file into a graphical computation application). In addition to this, controller 110 may also generate nodes for various topics, splitting nodes into specific usages of each topic.

Controller 110 may analyze communication across the tree structure with both a many-to-many relationship as well as a many-to-one relationship. In some examples, controller 110 may reference a predetermined list of topics to analyze (e.g., such that communication that relates to those topics are analyzed) and/or topics to avoid analyzing communication. In such examples, controller 110 may transfer available processing power from other tasks to analyzing communication when one of the predetermined topics to analyze is detected within communication.

As discussed herein, controller 110 may analyze received messages. For example, controller 110 may parse a received email that is in Multipurpose Internet Mail Extensions (“MIME”) or JavaScript Object Notation (“JSON”) format to eXtensible Markup Language (“XML”) or the like for analysis. Controller 110 may determine users of the message (e.g., looking to author, to, cc, or bcc fields), a data read, date received, and a topic of a message. In some examples, controller 110 may discount certain messages that are intended to be relatively private, such as messages that are received in bcc. For emails, controller 110 may identify all users of an expandable group. Controller 110 may further be configured to identify and disregard spam messages or the like (e.g., such as messages from outside of an expected origin domain). Controller 110 may identify the subject of the message using the NLP techniques described herein.

In some examples, controller 110 may analyze and then tag communication as belonging to one of many communication categories in order to better analyze the communication within those categories later. For example, controller 110 may identify communication as being categorized as an inspirational message (e.g., messages including strategies, linkages between work to a common goal, optimism building messages, aspirational messages, refocusing messages, or the like), an education message (e.g., an explanatory message, a skill building message, or a strategy building message), a reinforcing message (e.g., a message linking purpose to strategy, a message explaining tactics, a message relating to channels and communication channels for feedback), or the like. Controller 110 may store each message in a graphical format such as the following:

{“topic”: {topic-a, topic-b }, from: User A, to: User B, weight: 30, date: “Dec. 16, 2018”, read: “Dec. 16, 2018”}

In this format, topics A and B may be nodes. Further, users A and B may be nodes. In some examples, topics and users may be depicted as different shapes, where topics are circle-shaped nodes and users are square-shaped nodes, or the like, to better visually identify each. The graphical format may show that a single message or a series of messages that relates to both topic A and topic B between the two users. Further, the graphical format may indicate a weight of the message (e.g., indicated by a line weight) that shows if the communication was relatively normal (e.g., a single email without flags or the like) or was relatively strenuous (e.g., as indicated by many emails sent back and forth and/or an “important” flag or the like). In some examples, the graphical format may further include dates, such as dates that messages were went and/or read or the like.

In some examples, controller 110 may store communication as not identifying a specific name or identity of a user, but instead storing the communication between different roles. In this way, controller 110 may then analyze communication between roles across a company, identifying communication strengths or breakdowns as it is related to specific role relations.

As controller 110 gathers communication data, controller 110 may load this communication data for analysis (e.g., into the computation graphical application discussed above), therein updating the model by, e.g., incrementing existing edges (e.g., connections between nodes) based on co-occurrences (e.g., multiple messages along similar connections). Controller 110 may maintain these co-occurrences in a lookup table or the like for reference integrity. Controller 110 may identify if a message is unread, and/or generate a single directional edge to reflect that the message is unread.

When generating a report, controller 110 may then select a root (e.g., a source of a message) and topic to analyze. Controller 110 may use graph relationships or the like to analyze the communication patterns. Controller 110 may further use NLP techniques (e.g., converting the topic into a stem and lemma form) to track the communication through the graph (e.g., based on synonyms/anti-antonyms in the set of topic nodes). For example, controller 110 may selects the user nodes under the root in the graph to create a subgraph, and may then analyze the flow of information from topics over a period of time (e.g., a daily, weekly or monthly basis) for the organization.

Controller 110 may then calculate how well communication has been disseminated. For example, controller 110 may calculate how many users received a message related to the topic over a given time span. Controller 110 may identify specific users that have not received messages relating to the topic. Further, as described herein, controller 110 may trace or follow along the tree data structure to identify where and how communication failures occur, and the end result (e.g., a number of users that do not receive the data on the topic).

Controller 110 may further identify a general amount of communication and/or intensity of communication (e.g., when emails are flagged as important or the like) across the tree data structure over various time frames for reference by a user. As such controller 110 may not only evaluate whether messages are being communicated effectively, but controller 110 may also be configured to verify that communication is flowing through intended paths, and/or suggest improved paths, in addition to giving a user a chance to visualize how communication is currently traveling through an organization.

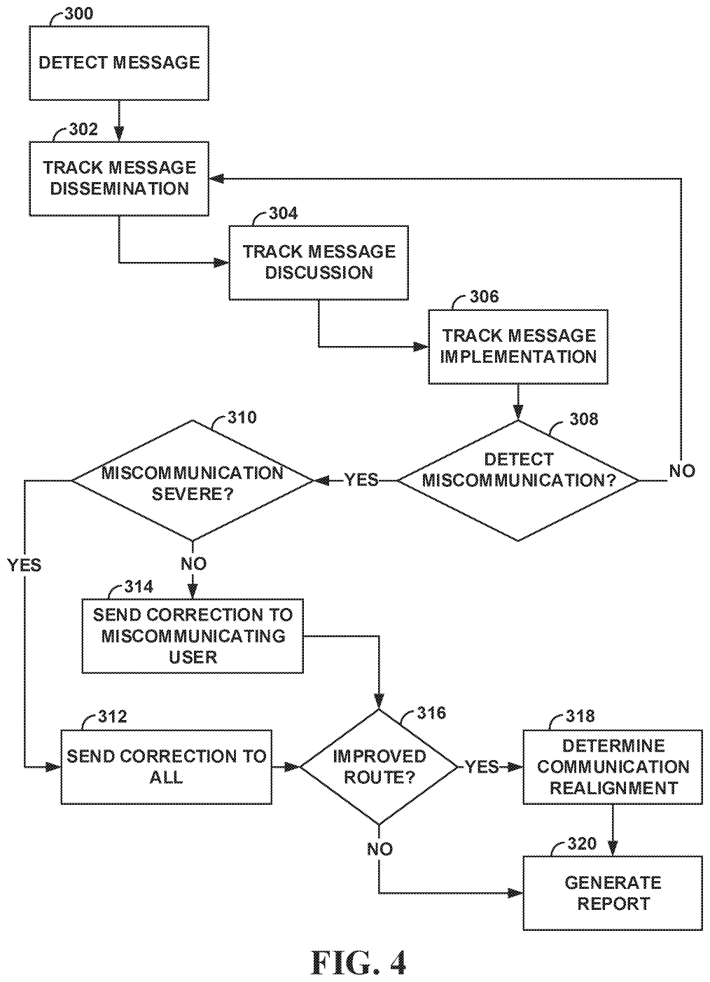

Controller 110 may evaluate and manage communication between a plurality of users of an organization according to many techniques. For example, controller 110 may evaluate and manage communication according to the flowchart depicted in FIG. 4. The flowchart of FIG. 4 is discussed with relation to FIG. 1 for purposes of illustration, though it is to be understood that other systems may be used to execute the flowchart of FIG. 4 in other examples. Further, in some examples system 100 may execute a different method than the flowchart of FIG. 4, or system 100 may execute a similar method with more or less steps in a different order, or the like.

Controller 110 may detect a message (300). The message may be sent over network 140. Controller 110 may track a dissemination of this message (302). For example, controller 110 may track this message as it is communicated across many levels of an organization. In some examples, controller 110 may evaluate a speed at which a message is disseminated. For example, controller 110 may determine a relatively faster dissemination of a message to be relatively better than a relatively slower dissemination.

Controller 110 may further track general conversation relating to this message (304). For example, controller 110 may track conversation between users that have received this message as discussed over chatting applications or the like. In some examples, controller 110 may identify these conversations as relating to this message where these conversations only reference a single element of the message. For example, controller 110 may identify that end users have received a message that included a first element of prioritizing a new coding technique, a second element about how to handle invoices, and a third element about the good work being done by the team, after which controller 110 identifies the end users discussing implementing the new coding technique over a web chat interface. Controller 110 may identify this discussion as relating to the message, even where the other elements of the message are not discussed.

Controller 110 may detect implementation relating to the message (306). For example, controller 110 may detect one or more user devices 120 creating work product that relates to one or more elements of the project. Controller 110 may determine whether or not there has been any miscommunication relating to the message (308). If controller 110 cannot detect any miscommunication, controller 110 may continue tracking the message (302-306).

In some examples, controller 110 may detect some miscommunication. Controller 110 may detect the miscommunication using NLP techniques on the messages. For example, controller 110 may use NLP techniques to extract syntactic and/or semantic meaning out of text including, but not limited to, facts (e.g., dates, amounts, times, deadlines, etc.) and tone (e.g., urgency, emphasis, importance, etc.). In this way, controller 110 may determine that elements such as these facts or tone change from a first message to a second message as the message is relayed across users down an org chart. .For example, controller 110 may detect a user forgetting an element when the user sent an email when disseminating the message, and/or controller 110 may detect users miscategorizing one or more elements as they discuss the message, and/or controller 110 may detect users implementing one or more aspects of a project in a way that is not aligned with the message. In response to such a determination, controller 110 may determine if the miscommunication is relatively severe (310).

In some examples, controller 110 may determine a miscommunication to be severe by evaluating a topic of the miscommunication. For example, controller 110 may have access to a predetermined list of topics that are relatively important, such as billing, deadlines, or the like. If controller 110 detects that a miscommunication relates to one of these topics, controller 110 may determine that the miscommunication is severe. Alternatively, or additionally, controller 110 may determine that a miscommunication is severe based on how much the message was miscommunicated. For example, if a message with five elements is then forwarded with only one of the five elements correctly transmitted, controller 110 may detect that the miscommunication is severe. Alternatively, if the message is relayed from a first user to a second user with four of the elements perfectly communicated and one of the elements slightly changed, controller 110 may determine that the miscommunication was not severe (e.g., that the miscommunication was minor).

If controller 110 determines that the miscommunication is severe, controller 110 may send a correction to the miscommunication to all users associated with the miscommunication (312). This may include each user that was initially sent the miscommunication and/or those users that had this miscommunication discussed with them. In some examples, the correction may also be sent to the initiating user that sent the first instance of the message, and/or a user that is on a higher level on an org chart than the user that generated the miscommunication.

In other examples, controller 110 may determine that the miscommunication is not severe, in response to which controller 110 may only send a correction to the miscommunicating user (314). Sending the correction to the miscommunicating user may enable to the miscommunicating user to correct the miscommunication with a minimal amount of embarrassment or stress or the like.

Upon sending the correction report to either the miscommunicating user (314) or to all associated users (312), controller 110 determines if there is an improved route for the communication (316). For example, controller 110 may analyze historical data to determine whether this is a relatively common miscommunication for this user. Controller 110 may determine that this is relatively common by identifying that the miscommunicating user has a historical amount of miscommunications that are above a threshold number or rate of miscommunications (e.g., by checking database 130 of previous communications). Controller 110 may determine whether or not the user makes mistakes regularly in general, and/or whether the miscommunicating user regularly makes mistakes for some varieties of messages (e.g., educational messages, or directive message) or with some varieties of elements (e.g., dates or amounts or the like).

Additionally, or alternatively, controller 110 may determine whether or not the miscommunicating user is involved with miscommunications when dealing with the receiving users. For example, controller 110 may determine that a miscommunicating user rarely has errors when communicating with one user but relatively frequently has errors when dealing with a second user (e.g., as a result of incompatible communication styles or a social tension between the two users or the like). Controller 110 may identify such a miscommunication fit by determining that the miscommunicating user regularly rarely has communication errors when communicating with a first user but regularly does when communicating with a second user. For example, controller 110 may identify this miscommunication fit as frequent implementation errors (e.g., errors that exceed a threshold) by the second user upon receiving messages from the miscommunicating user. Further, controller 110 may identify that the second user virtually never has implementation errors when the second user receives instruction from a third user that is on a similar level of an org chart as the miscommunicating user. As such, controller 110 may determine that an improved route exists.

Where controller 110 determines that an improved route may or does exist, controller 110 may determine the communication realignment (318). Controller 110 may determine the realignment to include information be routed through a new person on a similar level on an org chart as the miscommunicating user. Controller 110 may determine what type of messages or details or the like should be realigned. For example, controller 110 may determine to realign how messages are routed through an org chart for inspirational messages, or directive messages. Further, controller 110 may determine to realign how messages are routed through an org chart for elements such as dates or prices or preferred techniques or the like.

Controller 110 may generate a report relating to the miscommunication (320). The report may include any suggested realignment. If no realignment is suggested (e.g., such that an improved route is not determined as a result of the miscommunicating user being a historically reliably communicator), the report may generally include details of the detected miscommunication. This report may include a graphical representation of a flow of the message throughout the users, similar to the flowchart 160 of FIG. 2. In some examples, the report may include information on all miscommunications of the message. The report may also include data on how the miscommunication has impacted work product, such as an amount of time or money or the like that may be tracked back to the miscommunication.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
tracking, by a processor using computing agents on a plurality of computing user devices of an organization, element fidelity during dissemination of a plurality of messages across many hierarchical levels of the organization across a plurality of media platforms;
detecting, by the processor, a message of the plurality of messages that includes at least one element from an initiating user;
identifying, by the processor evaluating communication relating to the message as the message is disseminated across a plurality of users of the organization, one or more miscommunicated elements relating to the at least one element, wherein the one or more miscommunicated elements relate to an error in communicating the at least one element;
determining, by the processor evaluating how the message was disseminated across the plurality of users, one or more miscommunications of the message between one or more users of the plurality of users that resulted in the one or more miscommunicated elements;
immediately and autonomously sending, by the processor and to at least one of the plurality of users, a correction to the one or more miscommunications;
identifying, by the processor analyzing the communication, a miscommunicating user of the one or more users of the miscommunication the one or more miscommunicated elements;
determining, by the processor, to reroute some communication away from the miscommunicating user; and
providing, by the processor and to at least one of the plurality of users, a generated report that compiles data on the miscommunication and the determination to reroute some communication away from the miscommunicating user.

2. The method of claim 1, further comprising detecting, by the processor checking a historical database, that the miscommunicating user is involved in more than a threshold number of miscommunications, wherein the determining to reroute some communication away from the miscommunicating user is in response to detecting that the miscommunicating user is involved in more than the threshold number of miscommunications.

3. The method of claim 2, further comprising:
detecting that the one or more miscommunicated elements is a certain variety of communication elements; and
detecting that the miscommunications of the miscommunicating user from the historical database include the certain variety of communication elements,
wherein the some communication that is rerouted away from the miscommunicating user includes communication that relates to the certain variety of communication elements.

4. The method of claim 2, further comprising:
detecting that the message is a certain variety of message; and
detecting that the miscommunications of the miscommunicating user from the historical database include the certain variety of message,
wherein the some communication that is rerouted away from the miscommunicating user includes communication that relates to the certain variety of message.

5. (canceled)

6. The method of claim 1, further comprising generating, by the processor, a graphical representation of the communication across the plurality of users, wherein the graphical representation indicates the one or more users who were involved in the one or more miscommunications.

7. (canceled)

8. The method of claim 1, wherein users of the plurality of users are organized on the hierarchal levels, further comprising identifying one or more of the hierarchal levels at which the one or more miscommunications occurred.

9. The method of claim 8, further comprising:
detecting a relative severity of the miscommunication;
wherein the correction is sent to each of the one or more users in response to determining that the miscommunication is relatively severe; and
wherein the correction is sent to users of the one or more users that are on a relatively higher hierarchical level of the organization in response to determining that the miscommunication is relatively minor.

10. (canceled)

11. A system comprising:
a processor; and
a memory in communication with the processor, the memory containing instructions that, when executed by the processor, cause the processor to:
track, using computing agents on a plurality of computing user devices of an organization, element fidelity during dissemination of a plurality of messages across many hierarchical levels of the organization across a plurality of media platforms
detect, a message of the plurality of messages that includes at least one element from an initiating user;
identify, by evaluating communication relating to the message as the message is disseminated across a plurality of users of the organization, one or more miscommunicated elements relating to the at least one element, wherein the one or more miscommunicated elements relate to an error in communicating the at least one element;
determine, by evaluating how the message was disseminated across the plurality of users, one or more miscommunications of the message between one or more users of the plurality of users that resulted in the one or more miscommunicated elements
immediately and autonomously send, to at least one of the plurality of users, a correction to the one or more miscommunications;
identify, by analyzing the communication, a miscommunicating user of the one or more users of the miscommunication the one or more miscommunicated elements;
determine to reroute some communication away from the miscommunicating user; and
provide, to at least one of the plurality of users, a generated report that compiles data on the miscommunication and the determination to reroute some communication away from the miscommunicating user.

12. The system of claim 11, the memory further containing instructions that, when executed by the processor, cause the processor to detect, by checking a historical database, that the miscommunicating user is involved in more than a threshold number of miscommunications, wherein the determining to reroute some communication away from the miscommunicating user is in response to detecting that the miscommunicating user is involved in more than the threshold number of miscommunications.

13. The system of claim 11, the memory further containing instructions that, when executed by the processor, cause the processor to:
detect that the one or more miscommunicated elements is a certain variety of communication elements; and
detect that the miscommunications of the miscommunicating user from the historical database include the certain variety of communication elements,
wherein the some communication that is rerouted away from the miscommunicating user includes communication that relates to the certain variety of communication elements.

14. The system of claim 11, the memory further containing instructions that, when executed by the processor, cause the processor to:
detect that the message is a certain variety of message; and
detect that the miscommunications of the miscommunicating user from the historical database include the certain variety of message,
wherein the some communication that is rerouted away from the miscommunicating user includes communication that relates to the certain variety of message.

15. The system of claim 11, the memory further containing instructions that, when executed by the processor, cause the processor to generate a graphical representation of the communication across the plurality of users, wherein the graphical representation indicates the one or more users who were involved in the one or more miscommunications.

16. The system of claim 11, wherein users of the plurality of users are organized on the hierarchal levels, further comprising identifying one or more of the hierarchal levels at which the one or more miscommunications occurred.

17. A computer program product, the computer program product comprising a computer readable storage medium having program instructions embodied therewith, the program instructions executable by a computer to cause the computer to:
track, using computing agents on a plurality of computing user devices of an organization, element fidelity during dissemination of a plurality of messages across many hierarchical levels of the organization across a plurality of media platforms
detect, a message of the plurality of messages that includes at least one element from an initiating user;
identify, by evaluating communication relating to the message as the message is disseminated across a plurality of users of the organization, one or more miscommunicated elements relating to the at least one element, wherein the one or more miscommunicated elements relate to an error in communicating the at least one element;
determine, by evaluating how the message was disseminated across the plurality of users, one or more miscommunications of the message between one or more users of the plurality of users that resulted in the one or more miscommunicated elements;
immediately and autonomously send, to at least one of the plurality of users, a correction to the one or more miscommunications;
identify, by analyzing the communication, a miscommunicating user of the one or more users of the miscommunication the one or more miscommunicated elements;
determine to reroute some communication away from the miscommunicating user; and
provide, to at least one of the plurality of users, a generated report that compiles data on the miscommunication and the determination to reroute some communication away from the miscommunicating user.

18. The computer program product of claim 17, the computer readable storage medium further containing program instructions that, when executed by the computer, cause the computer to detect, by checking a historical database, that the miscommunicating user is involved in more than a threshold number of miscommunications wherein the determining to reroute some communication away from the miscommunicating user is in response to detecting that the miscommunicating user is involved in more than the threshold number of miscommunications.

19. The computer program product of claim 18, the computer readable storage medium further containing program instructions that, when executed by the computer, cause the computer to:
detect that the one or more miscommunicated elements is a certain variety of communication elements; and
detect that the miscommunications of the miscommunicating user from the historical database include the certain variety of communication elements,
wherein the some communication that is rerouted away from the miscommunicating user includes communication that relates to the certain variety of communication elements.

20. The computer program product of claim 18, the computer readable storage medium further containing program instructions that, when executed by the computer, cause the computer to:
detect that the message is a certain variety of message; and
detect that the miscommunications of the miscommunicating user from the historical database include the certain variety of message,
wherein the some communication that is rerouted away from the miscommunicating user includes communication that relates to the certain variety of message.
